(19) United States
(12) Patent Application Publication
(10) Pub. No.: US 2026/0132976 A1
(43) Pub. Date: May 14, 2026

(54) AIR PURIFIER FOR A REFRIGERATOR

(71) Applicant: LABORATORI FABRICI SRL, Pordenone (PN) (IT)

(72) Inventors: Vincenzo VITIELLO, Toscolano-Maderno (BS) (IT); Alessio D'ANDREA, San Giorgio Della Richinvelda (PN) (IT); Pietro Paolo Felice GANIS, Camino Al Tagliamento (UD) (IT)

(73) Assignee: LABORATORI FABRICI SRL, Pordenone (PN) (IT)

(21) Appl. No.: 19/118,944

(22) PCT Filed: Oct. 9, 2023
(86) PCT No.: PCT/IB2023/060128

§ 371 Date: Apr. 7, 2025

(30) Foreign Application Priority Data
Oct. 10, 2022 (IT) 102022000020832

(51) Int. Cl. F25D 17/04; B01J 21/12; B01J 23/68; B01J 35/39; B01J 37/02

(52) U.S. Cl. CPC F25D 17/042; B01J 21/12; B01J 23/687; B01J 35/39; B01J 37/0215; F25D 2317/0417

(57) ABSTRACT

An air purifier for use in refrigerators contains in the path for the flow of air through the purifier: a photocatalyst wherein a layer based on tungsten oxide (WO₃) is applied on a ceramic foam support. The layer may also contain tin oxide and silver oxide, as well as platinum. The oxide layer may be applied by immersion without the application of a primer. A method for increasing the shelf life of fruits, in particular also of strawberries, salad and vegetables in a refrigerator and a related refrigerator are also described. The purifier is characterized by low energy consumption, thanks to the use of white light to activate the photocatalyst, as well as little toxic impact.

### TECHNICAL FIELD

The present invention relates to an air purifier for use in refrigerators comprising a housing provided with an inlet for a fluid, in particular air, and an outlet for the fluid; and a photocatalysis chamber suitable for being passed through by said fluid and in communication with said inlet and said outlet, which in turn comprises a photocatalyst and a light source for activating the photocatalyst.

### STATE OF THE ART

Several air purifiers are known for keeping the indoor environment of homes and workspaces, industrial spaces and laboratories clean. These purifiers use the purifying abilities of plants or filters, including photocatalytic filters which are generally based on titanium oxide and are activated with ultraviolet (UV) light. The material itself and the UV rays give rise to a number of problems in terms of toxicity, such as the formation of ozone, and high energy consumption. In delicate environments, such as refrigerators for the conservation of foods, such purifiers are not ideal and are often unsatisfactory in eliminating odours and microorganisms in order to increase the shelf life of, for example, fruits and vegetables.

### DISCLOSURE OF THE INVENTION

The object of the invention is to overcome the aforesaid drawbacks and to propose an air purifier for use in refrigerators which is characterised by low energy consumption, reduced ozone emissions and non-toxic materials for humans. Another object of the invention is to propose a relative air purifier which during its use in the refrigerator reduces the total bacterial load so that the shelf life of vegetables, salad and fruits, in particular also strawberries, is significantly increased.

In a first aspect of the invention, the object is achieved by means of a purifier as initially described, in which the photocatalyst comprises a ceramic foam support coated with a layer containing tungsten trioxide and in which the light source is a visible light source.

Preferably, the fluid path is configured so that said photocatalytic filter is placed perpendicular to said path and thus to the fluid flow. Positioning the filter perpendicular to the flow makes it possible to minimise the load losses of the photocatalyst.

In a preferred embodiment of the invention, said visible light source for activating said photocatalyst comprises a plurality of LEDs which are arranged in a decagon wherein each vertex is occupied by one LED and two other LEDs are arranged so as to form a triangle with two LEDs positioned on two vertices of the same side of the decagon wherein the two sides forming a triangle with an additional LED are separated by another side of the decagon.

In another advantageous embodiment of the invention, the lower part of the housing has an annular opening in its bottom which surrounds a basket structure comprising fluid inlets on its sides and whose bottom corresponds to the bottom of the lower part of the housing. The inlets in the basket are in communication with the annular opening and thus with the outside.

The foamy ceramic substrate implies its porosity and allows to avoid using a primer for its coating with substances with photocatalytic activity, reducing treatment times and costs. A preferred bath for applying the coating layer based on WO₃ (e.g., the product CLC-W from Inpigest srl, Bodio Lomnago, Italy) is aqueous and preferably further comprises fixatives and accelerators.

In a preferred variant of the invention, the layer further comprises tin oxide and silver oxide. They are oxides which in combination with tungsten trioxide are useful in the abatement of the total bacterial count (TBC). A particularly suitable composition of the layer comprises the three oxides in a weight ratio of tungsten trioxide to tin oxide to silver oxide corresponding to 0.9-1.1:1.3-1.7:0.05-0.15, in particular at about 1:1.5:0.1.

The purifying effect can be further increased by adding platinum in which, advantageously, the weight ratio of platinum to tungsten trioxide is 0.9-1.1:0.9-1.1, in particular about 1:1. A ceramic foam support particularly suitable to be coated with said oxide-based layer, even without the use of a primer comprises aluminium oxide Al₂O₃ and silicon oxide SiO₂. Surprisingly, a ceramic filter for filtering molten aluminium and the molten alloys thereof is particularly suitable for the purposes of the invention. Advantageously, the pores of said ceramic foam support have a density of 8-10 ppi (pores per inch) which has proved to be particularly suitable for ensuring a sufficient flow rate of the fluid to be purified with the simultaneous cleaning of the fluid in chemical and microbiological terms.

In a highly preferred variant of the invention, the tungsten oxide-based layer is in direct contact with the ceramic foam support without having an intermediate layer of a primer. The coating adheres directly to the foamy ceramic.

Photocatalysis is a superficial phenomenon. A coating on a support which has a lot of available surface, i.e., the ceramic open-foam geometry, promotes photocatalysis. There is a need to have the lowest pressure drops, thus of substances with photocatalytic activity, to ensure the effectiveness of the system. The use of 8-10 ppi ceramic foam also helps to have low load drops. The supports to which WO₃ and other oxides and metals will be applied during the production of the filter are prepared to receive the material. The pre-treatment procedures involve cleaning the support; it is instead not necessary to apply a primer which promotes the adhesion of the photocatalytic material. The use of ceramic foams allows to skip the “primer” step, as they are very porous and allow a good fixing of the coating to the support.

A further aspect of the invention relates to a refrigerator for foods comprising an air purifier according to the invention. During the use of the purifier, such a refrigerator has an internal environment which is odourless and hardly chemically and microbiologically contaminated, which is capable of significantly increasing the shelf life of fruits, vegetables and salads. The air purifier can simply be placed in the refrigerator or fixed on its inner walls by relative fixing means.

A further aspect of the invention relates to a process for keeping the interior of a refrigerator clean and odourless and for increasing the shelf life of fruit, salad and vegetables and comprises the following steps:
(a) providing a refrigerator according to the invention;
(ii) activating the photocatalyst by illuminating it with the light source; and
(iii) circulating the air present in the refrigerator through said air purifier.

To generate a fluid flow from the inlet through the photocatalytic system to the outlet, the purifier according to the invention further comprises a fan or a pumping system.

A fourth aspect of the invention relates to a photocatalyst for air purifiers, in particular for use in refrigerators, which comprises a ceramic foam support based on Al₂O₃ and SiO₂ with a pore density of 8-10 ppi which is coated with a layer containing tungsten trioxide, tin oxide, silver oxide and advantageously platinum, preferably in a weight ratio of 0.9-1.1:1.3-1.7:0.05-0.15:0.9-1.1, in particular about 1:1.5:0.1:1.

Such a photocatalyst is particularly suitable for increasing the shelf life of fruit, vegetables and salad in a refrigerator, as will be illustrated below, and is thus particularly suitable for use in the air purifier for refrigerators according to the invention. The effect is particularly evident in the storage of strawberries, which usually tend to rot already after two/three days.

A further aspect of the invention relates to a process for producing a photocatalyst as referred to above, comprising the following steps:
(α) providing a ceramic foam support based on Al₂O₃ and SiO₂ with a pore density of 8-10 ppi, preferably cleaned with compressed air;
(β) immersing said ceramic foam support in an aqueous bath comprising tungsten trioxide, tin oxide, silver oxide, and preferably platinum, in a weight ratio of 0.9-1.1:1. 3-1.7:0.05-0.15:0.9-1.1, in particular about 1:1.5:0.1:1;
(γ) drying the support thus coated, preferably accelerated with direct jets of compressed air or by means of a dryer, preferably heated to 70-80° C.

In a highly preferred variant of the production process, no application of a primer occurs between step (α) and step (β). This is made possible thanks to the particular combination of support and coating. The evaporation of water usually lasts a few hours, for example three hours.

As an alternative to step (β), a spray treatment is conceivable using, for example, a gun with 1.5-2 mm diameter nozzle to spread a uniform veil on the surface of the supports.

The photocatalytic filter according to the invention is regenerable. Dirt on the filters may result from organic material deposited and not degraded by the photocatalyst, due to a poor efficiency of the photocatalyst after a long use thereof (low surface area, crystalline phase), uneven and/or insufficient and/or too brief lighting. The surface area and porosity of the photocatalyst are physical properties that influence the quality and behaviour of porous materials. Materials with identical weight and volume may differ in terms of surface activity and adsorption volume based on their specific surface area. Porosity is measured by heating the filter under vacuum to remove impurities and then analysing the adsorbed gas volume at specific pressures and at low temperatures, for example at 77K in liquid nitrogen. The BET (Brunauer Emmett Teller) theory is the most widely used model for determining area. To measure the pore size by means of gas adsorption, the isotherms are recorded from low pressures to saturation pressure. The pressure range is determined by the size range of the pores to be measured: microporous materials are measured by isotherms in a pressure range of about 0.00001 Torr to 0.1 Torr, whereas mesoporous materials typically in a pressure range from 1 Torr to about 760 Torr. As the areas of the materials are very small, krypton Kr had to be used as a gas to have a good accuracy of the surface area value S_{BET}. The photocatalytic filters according to the invention preferably have an S_{BET} value (m²/g) ranging from 0.9 to 0.44.

X-ray fluorescence (XRF) is an analysis technique which can be applied to most inorganic materials to identify materials foreign to the filter and determine the regeneration efficiency and residual materials on the filter. Different regeneration methods were tested using this technique.

A simple heating to the temperature of 250° C. is not sufficient, nor was a washing with hydrogen peroxide enough to regenerate the filter, while the combination of a washing with sodium hypochlorite and subsequently hydrogen peroxide with a final heat treatment was satisfactory. The immersion of the filter in 30% (w/w) hydrogen peroxide for 24 h and subsequently muffled in air at 250° C. for 5 hours always still indicated the presence of organic material. On the other hand, the treatment with hypochlorite was shown to be suitable. The material may, for example, be immersed in the hypochlorite solution for two hours, then recovered and immersed in a 3% (w/w) hydrogen peroxide solution and subsequent heating. Washing in hydrogen peroxide had the dual purpose of eliminating residual hypochlorite (and thus its odour which may be unpleasant) and further oxidising any residues resistant to the action of hypochlorite. The material thus treated was then heat treated. At the end of the treatment it was white. The tungsten W content in the sample was determined by plasma atomic emission spectroscopy (ICP-AES) analysis and demonstrated the resistance of tungsten oxide to regeneration.

The features and advantages described for one aspect of the invention may be transferred mutatis mutandis to the other aspects of the invention.

The industrial applicability is obvious, since it is possible to increase the shelf life of food with an air purifier, and this with a low energy consumption system which does not have toxicity problems.

The purposes and advantages will be further highlighted in the disclosure of preferred examples of embodiments of the invention given by way of non-limiting example only.

Variant and further features of the invention are the subject matter of the dependent claims. The description of preferred embodiment examples of the invention is given, by way of example and not of limitation, with reference to the attached drawings. In particular, unless otherwise specified, the number, shape, size and materials of the system and of the individual components may vary, and equivalent elements may be applied without deviating from the inventive concept.

### BRIEF DESCRIPTION OF THE DRAWINGS

FIG. 1 depicts a perspective view of an embodiment of the air purifier according to the invention.

FIG. 2 depicts a longitudinal section of the air purifier according to FIG. 1.

FIG. 3 depicts a perspective view of the photocatalytic filter used in the air purifier of FIG. 1.

FIG. 4 depicts a detail of the photocatalytic filter of FIG. 3 in cross section.

FIG. 5 depicts the results of measurements of the light intensity or heat map on the photocatalytic filter of FIG. 3 as a function of the number of LEDs (light-emitting diodes) applied.

FIG. 6 depicts, in a graph, the reduction of formaldehyde in the purifier with a photocatalytic filter based on titanium dioxide irradiated with UV light.

FIG. 7 depicts, in a graph, the reduction of formaldehyde in the purifier with a photocatalytic filter based on tungsten trioxide irradiated with visible light.

FIG. 8 depicts, in a graph, the reduction of the total bacterial count (TBC) in the purifier with a photocatalytic filter based on titanium dioxide irradiated with UV light.

FIG. 9 depicts, in a graph, the reduction of the total bacterial count in the purifier with a photocatalytic filter based on tungsten trioxide irradiated with visible light.

FIG. 10 depicts a perspective view of a second example embodiment of the air purifier according to the invention.

FIG. 11 depicts a longitudinal section of the air purifier according to FIG. 10.

FIG. 12 depicts the air purifier of FIG. 10 in a perspective view from below.

FIG. 13 depicts the results of light intensity or heat map measurements on the photocatalytic filter of the air purifier according to FIG. 10 as a function of the number of LEDs (light-emitting diodes) applied.

### DESCRIPTION OF A PREFERRED EMBODIMENT EXAMPLE

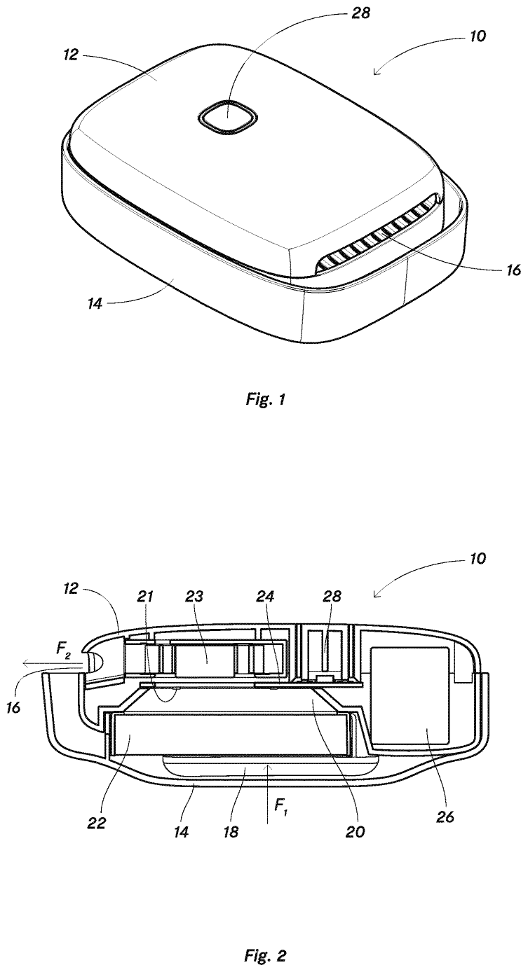

FIG. 1 shows a perspective view of an embodiment example of the air purifier 10 according to the invention comprising a housing with an upper part 12 and a lower part 14, one inserted in the other. Furthermore, an inlet 16 for the exit of air can be noted. Reference numeral 28 indicates the battery compartment.

The longitudinal section of the air purifier according to FIG. 1, as depicted in FIG. 2, better reveals the main parts of the system. The air enters (arrow F₁) the housing through inlets 18, passing through the photocatalytic filter 22 in the photocatalytic chamber 20 where LED lights 21 illuminate the upper surface of the photocatalytic filter 22 with perpendicular rays. After passing the filter 22 and the photocatalytic chamber 20, the air exits (arrow F₂) with the aid of a fan 23 from the purifier 10 through the outlet 16. The electronics 24 control the LEDs and the fan 23 which helps to create the air flow arriving through the space 18 perpendicularly on the filter 22. A battery in the battery compartment 28 powers the electronics 24. The element 26 acts as an interface with the LED ring button.

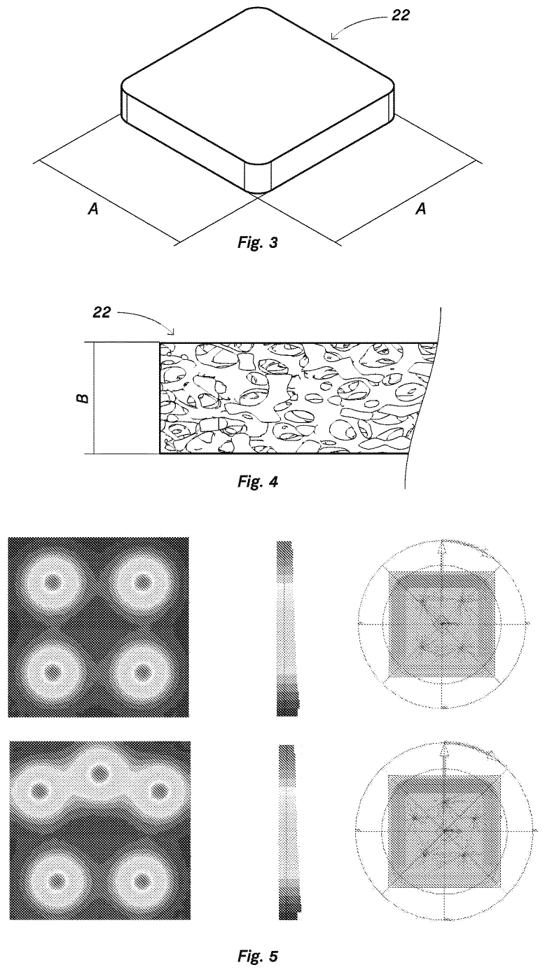

FIG. 3 depicts the photocatalytic filter 22 used in the air purifier of FIG. 1 in a perspective view, while FIG. 4 depicts a detail of the photocatalytic filter of FIG. 3 in cross section. Ceramic foam filters (for example of the brand VUKOPOR® A of the company Lanik s.r.o., Boskovice, Czech Republic) which were originally designed for the filtration of aluminium and non-ferrous metal alloys in foundries, in particular in the primary and secondary processing of molten metal, as well as for the filtration of melts in foundries, proved to be particularly suitable as filters. They have surprisingly proved very suitable in this completely different field of the invention and also allow to avoid a primer during their coating with the oxide WO₃. A typical feature of the structure of ceramic foam filters is the three-dimensional network of open pores which form a labyrinth in their ceramic body. It is this structure, along with the filter ceramic, which allows optimal coverage with the tungsten oxide layer and a homogeneous flow of the air over a large surface area. The filters have a typical homogeneous ceramic structure, with a minimum of restriction points on both the effective areas and inside the filter and are resistant to chemicals and heat. Their chemical composition has active adhesion strengths with respect to the substance to be applied.

For all types of filters, of various sizes and shapes, it is possible to provide them with sealing or expandable gaskets to fix them in the correct position and avoid filter bypassing flows. It is advisable to preheat the filter before the first use (350-400° C.), so as to obtain the maximum speed and filtration capacity. The ceramic material advantageously comprises Al₂O₃ and SiO₂. The porosity is 8-10 ppi (pores per inch).

Preferably, there are no closed pores, cracks or breaks in the active areas of the filter. The side lengths (A) and height (B) can vary as needed.

FIG. 5 depicts the results of light intensity measurements, or the heat map on the photocatalytic filter of FIG. 3 as a function of the number of light sources (LEDs) applied. The lighter the image, the higher the light intensity. The chosen light configurations can be seen on the right, the light intensity (heat) images generated by the configurations on the right can be seen on the left in a top view. The middle drawings show the corresponding heat intensity scales (heat increases with clarity).

Each photocatalyst needs a specific wavelength to be activated. WO₃ requires and allows a wavelength which falls within visible light, advantageously equal to about 450 nm. For example, 300 lux are needed on the filter surface to make it active. The lux which reach the filter can be modulated by the intensity of the LEDs (measured in lumens), the distance of the LEDs from the surface of the photocatalyst and the number of LEDs used. Based on the choice of number of LEDs and lumens of each LED, the power required to operate them and therefore also the related power consumption will vary. In the purifier according to the invention, the illumination of the filter has been optimised with the aim of minimising the associated energy consumption. In this sense, filter illumination as uniform as possible can be achieved with an increase in LEDs, the reduction of lux zones <300 and the reduction of lux zones >>300. As can be seen from the analyses depicted in FIG. 5, by increasing the number of LEDs it is possible to limit the areas with an excessive amount of lux for this application. This also results in a lower energy absorption, which in the specific case depicted was equal to a reduction from a total 110 mW to 100 mW.

Switching from UV-A LED to activate the titanium oxide-based coating has energy benefits. In terms of power absorbed, with the same number of LEDs and their positioning, it emerges that, in a concrete example, with UV LEDs and TiO₂ photocatalyst, the electrical power absorbed by the LEDs was limited by the firmware to 3.75% of their capacity, bringing each LED to an electrical power absorption of about 50 mW, for a total of 200 mW. With white LEDs and WO₃ photocatalyst, the maximum power which could be absorbed by each white LED was approximately 43 mW. By default, the value was set to 50%, thus bringing the power to a value of about 21.5 mW. Under the same conditions, i.e., both UV LEDs and white LEDs at 100% of the possible power, the current consumption of white LEDs was-98% with respect UV LEDs, a considerable saving in terms of energy. A further point in favour is that with white LEDs it is possible to put them all in series, halving the current consumption with respect to the case of UV LEDs which are instead forced to be divided into different branches. Lastly, the UV LEDs have a life of 3,000-4,000 hours, while white LEDs have a life of 40,000-60,000 hours, which in terms of environmental pollution ensures less waste creation and also a lower cost for the user.

In the tests performed in the laboratory using a prototype, the actual difference in efficacy of the new WO₃ coating with respect to the TiO₂ coating was investigated. In the case of TiO₂, unlike tungsten oxide-based filters, the TBC after eight hours is not zeroed.

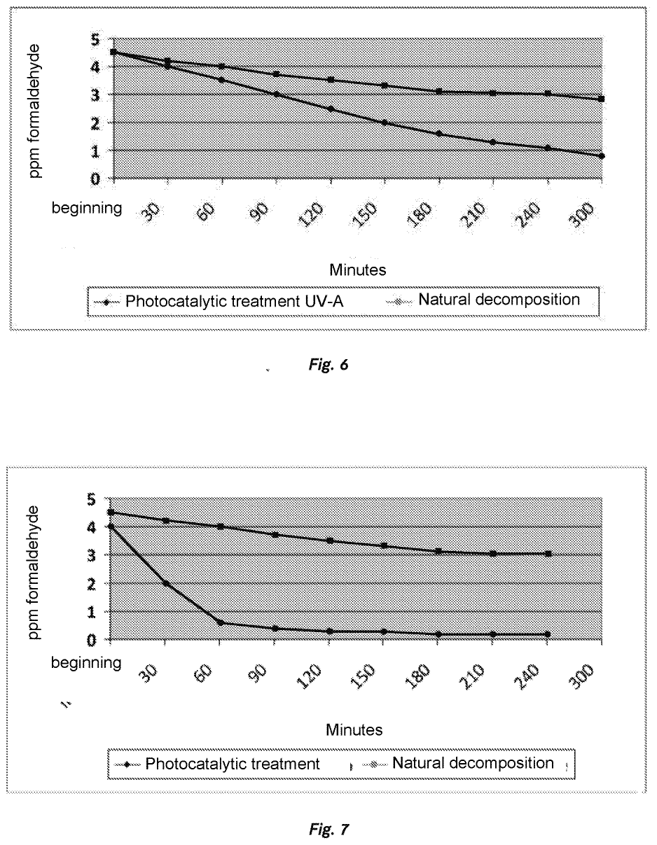

FIG. 6 depicts, in a graph, the reduction of formaldehyde in the purifier with a photocatalytic filter based on titanium oxide irradiated with UV light. With respect to a natural decay (upper curve), the use of the TiO₂-based filter reduces the formaldehyde concentration faster with a fairly linear trend. Sampling was carried out at initial contamination, after 60 min, 150 min, 300 min of photocatalytic treatment, the other points were inserted by interpolation.

In comparison, FIG. 7 depicts, in a graph, the reduction of formaldehyde in the purifier with a photocatalytic filter based on tungsten oxide irradiated with visible light. The tungsten trioxide filter reduces formaldehyde very quickly in the first two hours and almost eliminates it after two hours.

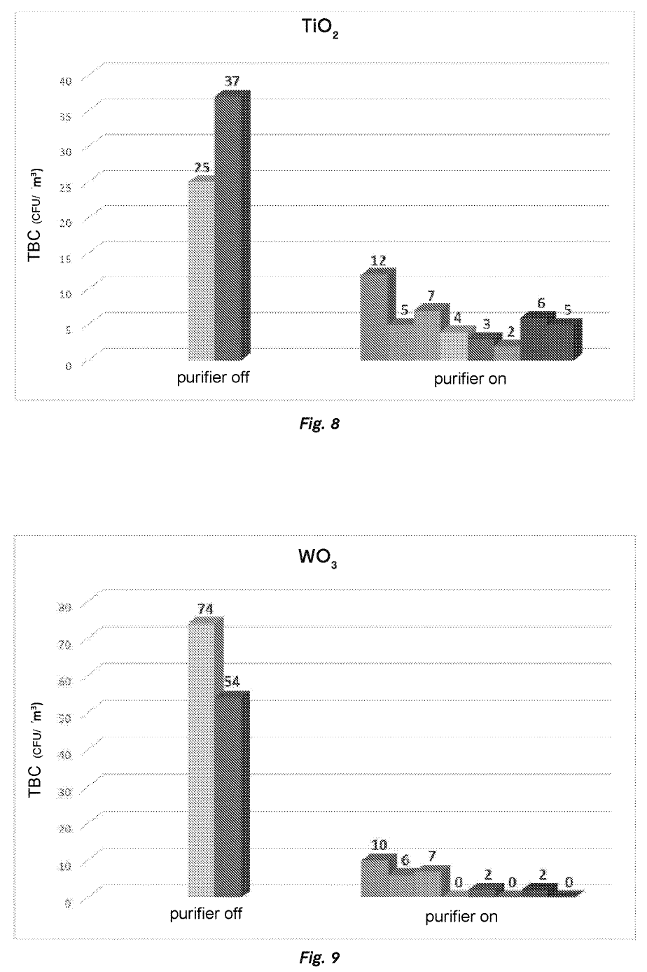

In both graphs of FIGS. 8 and 9, on the left the TBC can be seen at 0 and 10 min with the purifier off, and on the right the samples at 1 hour, 2 hours, . . . up to 8 hours after turning the purifier on.

From the results it can be seen that the visible light system is faster and above all durable over time.

In 2020, TiO₂ was defined by the IARC (International Agency for Research on Cancer) as a possible carcinogen for humans (group 2B), and in 2021, after having been used for years in the food industry, it was defined as unsafe as a food additive (EFSA-European Food Safety Authority). Tungsten trioxide is identified with CAS number 1314-35-8 and EC number 215-231-4. The full dossier is available on the European Chemical Agency (ECHA) website: https://echa.europa.eu/registration-dossier/-/registered-dossier/15315/2/3. WO₃ is classified as non-PBT (Persistant, Bioaccumulative and Toxic) and non-vPvB (very Persistant very Bioaccumulative). The European Food Safety Authority (EFSA) expressed a positive opinion on the use of WO₃ (CAS No 39318-18-8) as an additive in materials in contact with foods.

FIG. 8 depicts in a graph the reduction of the total bacterial count in the purifier with a photocatalytic filter based on titanium oxide irradiated with UV light, while FIG. 9 depicts in a graph the reduction of the total bacterial count in the purifier with a photocatalytic filter based on tungsten oxide irradiated with visible light.

Laboratory tests showed that the purifier according to the invention, thanks to photocatalytic technology, removes more than 80% of odours and VOCs (Volatile Organic Compounds) from the refrigerator, preventing cross-contamination between foods in the refrigerator and alterations of the organoleptic properties.

The inventors collaborated with INSTM (National Inter-university Consortium for Materials Science and Technology) to carry out a test in which an artificial pollution with two odorous compounds was used. It was verified that the purifier kills 80% of the selected compounds in 24 h, 50% in 5 hours. The test was performed with hexanal and pentylbutyrate, which are molecules which resemble, when present in high concentrations, the odour of rancidity. ArcoSolution (a spin-off of the University of Trieste) carried out a test to reduce the real pollution of the refrigerator: it was verified that the concentration of VOCs in a freshly filled refrigerator thanks to the purifier remains very low, and after only 5 hours there is a reduction of 80%. The purifier according to the invention, thanks to photocatalytic technology, reduces the bacterial and fungal load on foods in the refrigerator, even up to 10 times, and increases the shelf life of fruits, salads and vegetables by up to 7 days, postponing the appearance of wilting, softening, stains and rot.

From the tests it emerges that WO₃ has a more rapid and above all long-lasting reduction of the total bacterial count; it should be noted that already after the fourth hour of operation the total bacterial count (TBC) oscillates between 0 and 2, which microbiologically and statistically speaking are almost similar in meaning.

The superiority of the tungsten oxide (WO₃) based filter with respect to titanium oxide (TiO₂) based filters was thus demonstrated in two tests, one microbiological and one chemical.

The microbiological test was carried out in about 8 m³, the chemical test in an environment of about 4 m³. The devices tested were placed one at a time at the centre of the test environment, the sampling of the pollutant was carried out with an instrument called “Uniphos precision air sampling pump” consisting of a high-precision manual pump, in which colorimetric vials are inserted that are colored proportionally based on the amount of the analyte to be detected present in the aspirated air (method: Standard EN ISO 17621:2015). In the case of TiO₂ the reduction after one hour was 67.6%, after eight hours 86.5%, while in the case of WO₃ the reduction after one hour was 81.5% and after eight hours 99.9%.

The best-known photocatalyst is titanium dioxide, TiO₂, and it is the most widely used material to date. The TiO₂ needs UV light in order to activate. In the purifier according to the invention, the photocatalyst is based on tungsten trioxide, WO₃ with several advantages: it is a safer material, as ozone is not produced because UV-band light is not used and avoids the application of a stricter regulation for use, as visible light rays are not harmful if they come into contact with the eyes; it is a less expensive technology given the lower costs for visible light LEDs and given their lower energy consumption; and WO₃ has greater air purification effectiveness.

A test conducted showed that in the short term (five hours of continuous operation) there is no ozone emission; a low presence of ozone is observed after 24 hours of work, probably due to the heat released in 24 hours of continuous operation in performance mode in a sealed hood of less than one cubic metre (0.57 m³). The value recorded is in any case negligible and clearly lower with respect to the threshold value indicated by the WHO (World Health Organization) of 0.2 mg/m³. A value more than 100 times lower was recorded. For the test, the purifier according to the invention was switched on for 5 hr and 24 hr in a sealed hood of size 1.70 m×45 cm×75 cm, inside which only ambient air was present. The analysis was carried out with an Impinger solution characterized by iodine ions that capture ozone to form iodinated ions, as reported in the scientific article “Determination of Ozone in air by Neutral and Alkaline Iodide procedures”, D. H. Byers, B. E. Satzman, American Industrial Hygiene Association Journal, (1958), 19(3), 251-257. It was observed that in the short term there was no ozone emission, a low presence of ozone was observed after 24 hours of work, probably due to the heat released by the device in 24 hours of continuous operation in a sealed hood of less than one cubic metre (0.57 m³).

Energy consumption was monitored in order to understand the habits of users in relation to the use of the home refrigerator. It emerged that the door is opened 20 to 50 times a day (32 times on average). This affects 7% of annual energy consumption (up to a maximum of 23%), on average around 50 to 120 kWh: the equivalent of 20 dishwasher cycles or 50 washing machine cycles. The refrigerator consumption is directly proportional to its cooling cycles conducted by the compressor, especially in the case of those with a fixed frequency. Since each opening of the refrigerator involves the introduction of air that is not yet clean and the need to activate the purifier more often, an energy saving in the purifier is desirable.

In the foods tested in the laboratory and stored in the refrigerator with the purifier according to the invention, it was observed that bacterial and fungal contamination are kept-in the monitored period of time-generally lower (even by 1-2 orders of magnitude, which means 1 versus 10 and 100) with respect to the respective products kept in the refrigerator without a purifier.

The organoleptic evaluations show that the purifier is effective in slowing down the ageing of the tested products, postponing the appearance of wilting, softening, stains and rot. The evidence emerging from the study yields encouraging results regarding the ability of the purifier to extend the shelf life of fresh food products stored in the refrigerator, as shown in the following table 1:

TABLE 1

| | Food shelf life in | Food shelf life in | Estimated | |
|---|---|---|---|---|
| | fridge WITHOUT | fridge WITH | increase | Change |
| Food | purifier [days] | purifier [days] | (n times) | [%] |
| Strawberry | 3 | 10 | 3.3 | +70% |
| Apricot | 10 | 17 | 1.7 | +41% |
| Cherry | 14 | 22 | 1.6 | +36% |
| tomato | | | | |
| Belgian | 3 | 7 | 2.3 | +57% |
| endive | | | | |
| Courgette | 10 | 22 | 2.2 | +55% |

To make the photocatalytic coating of the porous ceramic support, a coating solution with the following ingredients (pH 7.5 to 9.5) was shown to be useful:

| Ingredient | C.A.S. number | Percentage (m/m %) |
|---|---|---|
| Water | 7732-18-5 | 98~99 |
| Tin oxide | 18282-10-5 | ~1.5 |
| Silicon oxide | 7631-86-9 | ~2 |
| Silver oxide | 20667-12-3 | ~0.1 |
| Ammonia | 7664-41-7 | ~0.1 |
| Tungsten trioxide (WO₃) | 1314-35-8 | ~1 |
| Platinum | 7440-06-4 | ~1 |

The ingredients are non-toxic in small concentrations (e.g.: toxic concentration of WO₃→840 mg/kg).

Finally, a second example embodiment of the air purifier according to the invention is described, which provides, in addition to slightly different construction choices, certain differences and equalities with respect to the first example embodiment of the air purifier illustrated in particular with reference to FIGS. 1 to 5.

FIG. 10 shows in a perspective view the second embodiment of the air purifier 10′ according to the invention comprising a housing with an upper part 12′ and a lower part 14′, one inserted into the other. Also noted is an opening 16′ for the escape of air. The reference number 28′ indicates the battery compartment. In both examples, walls can be seen in the opening 16′ which basically have two functions: they are affordance elements for the opening of the product and serve as protection for the fan.

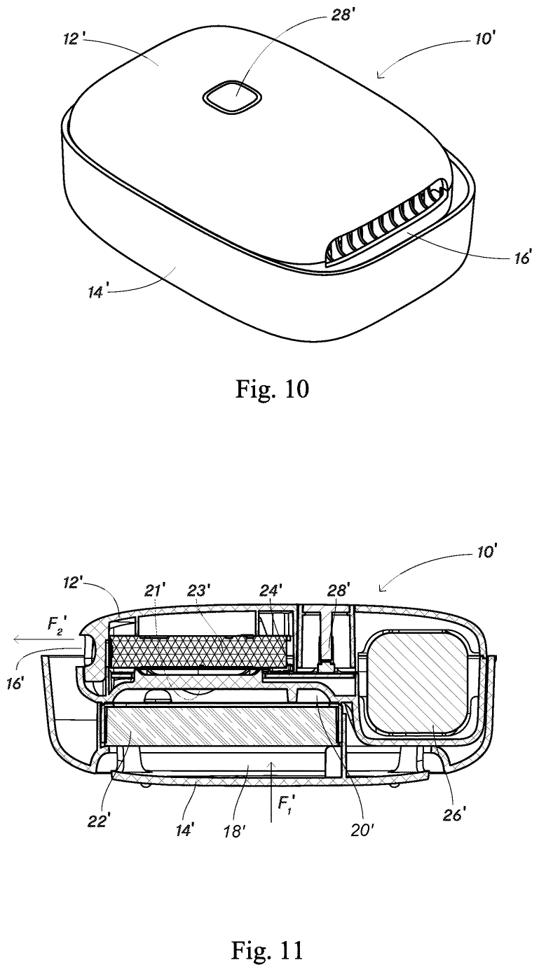

The longitudinal section of the air purifier according to FIG. 10, as depicted in FIG. 11, better reveals the main parts of the system. Through openings 18′, air (arrow F₁′) enters the housing passing through the photocatalytic filter 22′ into the photocatalytic chamber 20′ where LED lights 21 (LEDs are not visible, the reference number indicates their approximate position) illuminate the upper surface of the photocatalytic filter 22′ with perpendicular beams. After passing through the filter 22′ and the photocatalytic chamber 20′, air exits (arrow F₂′) with the help of a fan 23′ from the purifier 10′ through the outlet 16′. The electronics 24′ controls the LEDs and the fan 23′ which helps create the air flow through the space 18′ perpendicularly over the filter 22′. A battery in the battery compartment 28′ powers the electronics 24′. The element 26′ acts as a push-button interface to the LED ring.

In this executive example, the 23′ fan is larger than in the first executive example, increasing the performance of the 10′ purifier; likewise, the battery has different dimensions, so that only the LEDs on the board are visible and not all the other elements.

Construction changes in the housing allow the insertion of elements (batteries, fans, catalysts, . . . ) of different sizes; as help to choose different positions for the air inlet, e.g. from below and/or from the side.

The photocatalytic filter 22′ used in the air purifier 10 of FIG. 10 (second executive example) corresponds to the photocatalytic filter 22 of the air purifier 10′ shown in FIG. 1 (first executive example). The lengths of the sides (A′) and the height (B′) of the photocatalytic filter 22′ may vary as required.

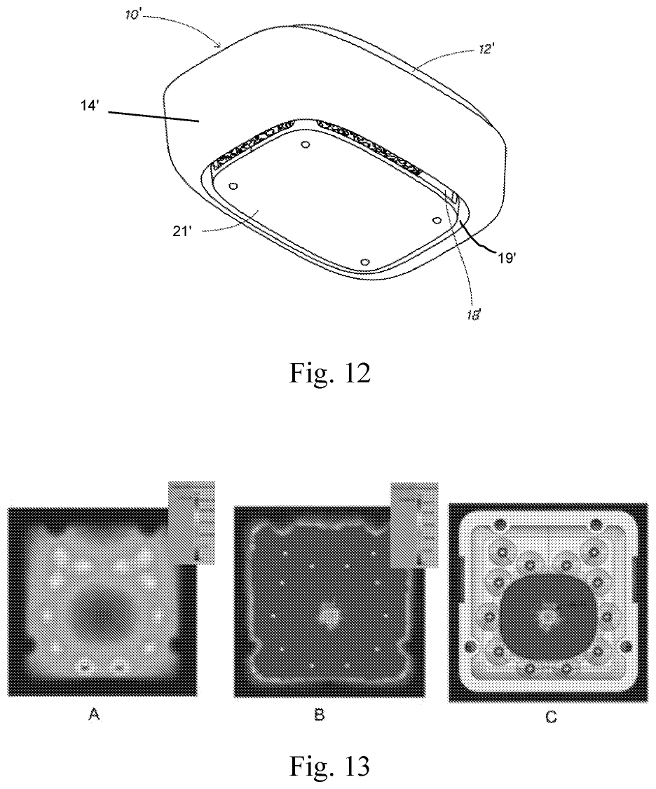

FIG. 12 shows the air purifier 10′ from FIG. 10 in a perspective view from below. Compared to the photocatalytic filter 10 of FIG. 1, the inlet 18′ is located not in the side part of the air purifier 10′, but in the lower part. In this regard, the lower part 14′ of the housing (12′, 14′) has in its bottom an annular opening 19′ surrounding a basket structure 21′ comprising the inlets 18′ on its sides and whose bottom corresponds to the bottom of the lower part 14′ of the housing.

FIG. 13 depicts the results of the light intensity measurements, i.e. the heat map on the photocatalytic filter in FIG. 12 as a function of the number of light sources (LEDs) applied. The brighter the image, the higher the light intensity. Compared with photocatalytic filter 22 in the first executive example, the arrangement of the LEDs changes, which here is essentially circular (with two additional LEDs slightly outside the circle).

The left image A shows how the 22′ filter is illuminated with a range from 0 to 11k lux, the middle image B confirms the same result with a range from 0 to 300 lux (target value for system operation. The large circular area circumscribes the zone where the filter is operating correctly. Compared to the LED arrangements in FIG. 5, operation has been optimised.

In the image to the right C, the arrangement of the individual LEDs can be seen. In the pictures, the small central area indicates that there is a small area that does not work as specified, but less than 300 lux; this is a compromise chosen by the inventors to optimise battery consumption. Should problems occur, it is sufficient to raise the brightness of the LEDs slightly to cover the central ‘defective’ area as well.

The configuration of the LEDs in this executive example can also be described as a decagon in which each LED occupies one vertex and two further LEDs are arranged to form a triangle with two LEDs positioned on two vertices on the same side of the decagon where the two sides forming a triangle with an additional LED are separated by another side of the decagon. This arrangement of LEDs is particularly advantageous for making almost optimal use of the photocatalytic filter while saving on battery consumption.

The second executive example, in particular due to the special configuration of the inlets 18′ located in a basket structure 21′ accessible from below through an annular opening 19′ in the bottom 14′ of the housing, consumes ˜25% less power to process the same flow rate.

1. An air purifier for use in refrigerators comprising:
(a) a housing provided with an inlet for a fluid, in particular air, and an outlet for the fluid;
(b) a photocatalysis chamber suitable for being passed through by said fluid and in communication with said inlet and said outlet, comprising
(b-1) a photocatalyst comprising a ceramic foam support coated with a layer containing tungsten trioxide; and
(b-2) a visible light source for activating said photocatalyst.

2. The air purifier according to claim 1, wherein a fluid path is preferably configured in such a way that said-filter photocatalyst is placed perpendicular to said fluid path and thus to a fluid flow.

3. The air purifier according to claim 1, wherein said layer further comprises tin oxide and silver oxide.

4. The air purifier according to claim 3, wherein the weight ratio of tungsten trioxide to tin oxide to silver oxide corresponds to 0.9-1.1:1.3-1.7:0.05-0.15, in particular to about 1:1.5:0.1.

5. The air purifier according to claim 3, wherein the air purifier further comprises platinum, preferably with a weight ratio of platinum to tungsten trioxide of 0.9-1.1:0.9-1.1, in particular about 1:1.

6. The air purifier according to claim 1, wherein said ceramic foam support comprises aluminum oxide Al₂O₃ and SiO₂.

7. The air purifier according to claim 1, wherein pores of said ceramic foam support have a density of 8-10 ppi (pores per inch).

8. The air purifier according to claim 1, wherein said layer comprising tungsten trioxide is in direct contact with said ceramic foam support without presenting an intermediate layer of a primer.

9. The air purifier according to claim 1, wherein said visible light source for activating said photocatalyst comprises a plurality of LEDs which are arranged in a decagon in which each vertex is occupied by one LED and two further LEDs are arranged so as to form a triangle with two LEDs positioned on two vertices of the same side of the decagon in which the two sides forming a triangle with an additional LED are separated by another side of the decagon.

10. The air purifier according to claim 1, wherein a lower part of the housing has in a bottom an annular opening surrounding a basket-shaped structure comprising said inlets on sides of said basket-shaped structure and wherein a bottom of said basket-shaped structure corresponds to the bottom of the lower part of the housing.

11. A food refrigerator comprising an air purifier comprising:
(a) a housing provided with an inlet for a fluid, in particular air, and an outlet for the fluid;
(b) a photocatalysis chamber suitable for being passed through by said fluid and in communication with said inlet and said outlet, comprising
(b-1) a photocatalyst comprising a ceramic foam support coated with a layer containing tungsten trioxide; and
(b-2) a visible light source for activating said photocatalyst.

12. A process for keeping the interior of a refrigerator clean and odourless and for increasing the shelf life of fruit and vegetables comprising the following steps:
(i) providing a refrigerator according to claim 11;
(ii) activating the photocatalyst by illuminating the photocatalyst with said visible light source; and
(iii) circulating air present in the refrigerator through said air purifier.

13-15. (canceled)

16. The air purifier according to claim 4, wherein the air purifier further comprises platinum with a weight ratio of platinum to tungsten trioxide of 0.9-1.1:0.9-1.1, in particular about 1:1.

17. The air purifier according to claim 16, wherein said ceramic foam support comprises aluminum oxide Al₂O₃ and SiO₂.

18. The air purifier according to claim 17, wherein pores of said ceramic foam support have a density of 8-10 ppi (pores per inch).

19. The air purifier according to claim 18, wherein said layer comprising tungsten trioxide is in direct contact with said ceramic foam support without presenting an intermediate layer of a primer.
